(19) United States
(12) Patent Application Publication
(10) Pub. No.: US 2009/0013491 A1
(43) Pub. Date: Jan. 15, 2009

(54) Windshield Wiper Blade Having Lower Cost of Fabrication

(76) Inventor: Geng-Shen Su, Sinshih Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/775,575

(22) Filed: Jul. 10, 2007

(51) Int. Cl. B60S 1/38

(52) U.S. Cl. 15/250.361

(57) ABSTRACT

A windshield wiper blade includes an elastic plate and a rubber enclosure enclosed around the elastic plate. Thus, the elastic plate is enclosed by the rubber enclosure which is formed integrally so that the windshield wiper blade is made easily and quickly, thereby decreasing the costs of fabrication. In addition, the wiper of the rubber enclosure has multiple arc-shaped chamfered corners to prevent the wiper of the rubber enclosure from being worn out during the wiping movement process. Further, the elastic plate is fully enclosed by the rubber enclosure so that the elastic plate is not exposed to the ambient environment to prevent the elastic plate from being rusted or eroded, thereby maintaining the elasticity of the elastic plate, and thereby enhancing the lifetime of the elastic plate.

### BACKGROUND OF THE INVENTION

1. Field of the Invention

The present invention relates to a windshield wiper blade and, more particularly, to a windshield wiper blade for a car.

2. Description of the Related Art

A conventional windshield wiper blade 1 in accordance with the prior art shown in FIGS. 12-14 comprises a press plate 10, two elastic plates 12 mounted in the press plate 10, two end caps 11 mounted on two opposite ends of the press plate 10 respectively to cover the elastic plates 12, and a wiper 13 mounted on the press plate 10. The press plate 10 consists of a hard rubber strip 101 and a soft strip 102 which are made of different materials and are combined with each other to allow insertion of the elastic plates 12 into the soft strip 102 and insertion of the wiper 13 into the hard rubber strip 101. The soft strip 102 of the press plate 10 has an inside formed with a slot 104, and the hard rubber strip 101 of the press plate 10 has an upper portion formed with a rib 103 inserted into and bonded in the slot 104 of the soft strip 102 and a lower portion formed with a snapping groove 105. The wiper 13 is snapped into the snapping groove 105 of the hard rubber strip 101 and has multiple right-angled corners 130. The inside of the soft strip 102 of the press plate 10 is formed with two insertion grooves 106 to allow insertion of the elastic plates 12.

However, the windshield wiper blade 1 consists of multiple parts so that the windshield wiper blade 1 is not made easily and quickly, thereby increasing the costs of fabrication. In addition, the windshield wiper blade 1 has a complicated construction so that the windshield wiper blade 1 is not assembled easily and quickly. Further, the wiper 13 has multiple right-angled corners 130 which easily produce stress concentration so that the wiper 13 is easily worn out during the wiping movement process. Further, gaps are defined between the insertion grooves 106 of the soft strip 102 of the press plate 10 and the elastic plates 12 so that the elastic plates 12 are easily rusted or eroded due to the rain or wet air, thereby affecting the elasticity of the elastic plates 12, and thereby decreasing the lifetime of the elastic plates 12.

### BRIEF SUMMARY OF THE INVENTION

In accordance with the present invention, there is provided a windshield wiper blade, comprising an elastic plate and a rubber enclosure enclosed around the elastic plate.

The primary objective of the present invention is to provide a windshield wiper blade having lower cost of fabrication.

Another objective of the present invention is to provide a windshield wiper blade, wherein the elastic plate is enclosed by the rubber enclosure which is formed integrally so that the windshield wiper blade is made easily and quickly, thereby decreasing the costs of fabrication.

A further objective of the present invention is to provide a windshield wiper blade, wherein the windshield wiper blade has a simplified construction, thereby decreasing the price of material, and thereby saving the manufacturing time.

A further objective of the present invention is to provide a windshield wiper blade, wherein the wiper of the rubber enclosure has multiple arc-shaped chamfered corners to prevent the wiper of the rubber enclosure from being worn out during the wiping movement process.

A further objective of the present invention is to provide a windshield wiper blade, wherein the elastic plate is fully enclosed by the rubber enclosure closely and snugly so that the elastic plate is not exposed to the ambient environment to prevent the elastic plate from being rusted or eroded due to the rain or wet air, thereby maintaining the elasticity of the elastic plate, and thereby enhancing the lifetime of the elastic plate.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a windshield wiper blade in accordance with the preferred embodiment of the present invention.

FIG. 2 is a side cross-sectional assembly view of the windshield wiper blade taken along line 2-2 as shown in FIG. 1.

FIG. 3 is a locally enlarged view of the windshield wiper blade as shown in FIG. 2.

FIG. 4 is a side cross-sectional assembly view of a windshield wiper blade in accordance with another preferred embodiment of the present invention.

FIG. 5 is a side cross-sectional assembly view of a windshield wiper blade in accordance with another preferred embodiment of the present invention.

FIG. 6 is a side cross-sectional assembly view of a windshield wiper blade in accordance with another preferred embodiment of the present invention.

FIG. 7 is a side cross-sectional assembly view of a windshield wiper blade in accordance with another preferred embodiment of the present invention.

FIG. 8 is a side cross-sectional assembly view of a windshield wiper blade in accordance with another preferred embodiment of the present invention.

FIG. 9 is a side cross-sectional assembly view of a windshield wiper blade in accordance with another preferred embodiment of the present invention.

FIG. 10 is a side cross-sectional assembly view of a windshield wiper blade in accordance with another preferred embodiment of the present invention.

FIG. 11 is a side cross-sectional assembly view of a windshield wiper blade in accordance with another preferred embodiment of the present invention.

FIG. 12 is an exploded perspective view of a conventional windshield wiper blade in accordance with the prior art.

FIG. 13 is a partially enlarged perspective view of the conventional windshield wiper blade as shown in FIG. 12.

FIG. 14 is a side cross-sectional assembly view of the conventional windshield wiper blade as shown in FIG. 12.

### DETAILED DESCRIPTION OF THE INVENTION

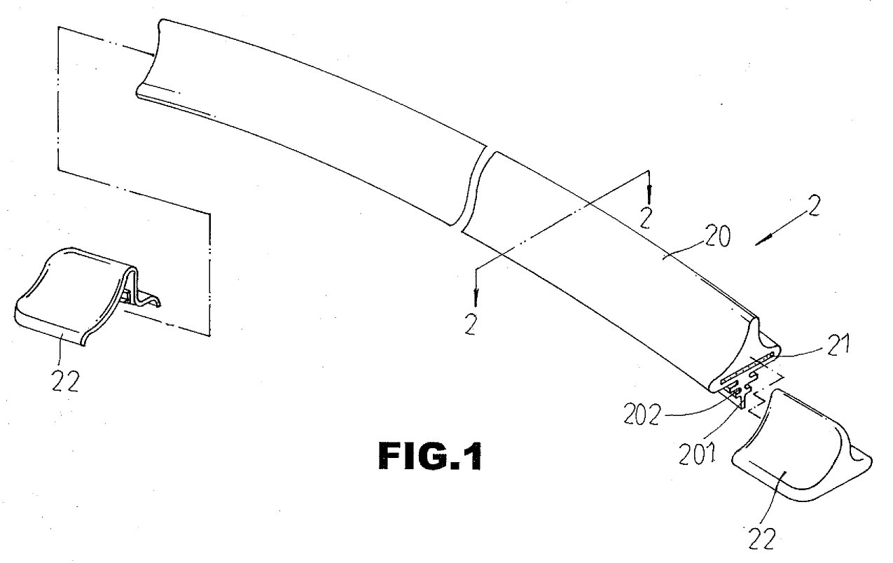

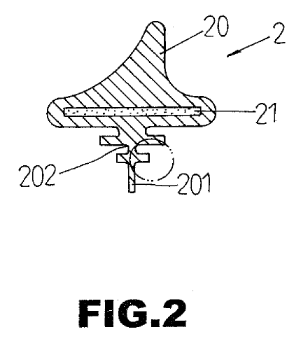

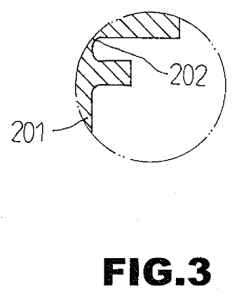

Referring to the drawings and initially to FIGS. 1-3, a windshield wiper blade 2 in accordance with the preferred embodiment of the present invention comprises an elastic plate 21, a rubber enclosure 20 enclosed around the elastic plate 21, and two end caps 22 mounted on two opposite ends of the rubber enclosure 20 respectively to cover the elastic plate 21.

The elastic plate 21 has a substantially flat-shaped cross-sectional profile.

The rubber enclosure 20 is formed integrally by a molding process and is enclosed around a whole periphery of the elastic plate 21 which has two opposite ends exposed from the two opposite ends of the rubber enclosure 20 respectively and covered by the two end caps 22 respectively. The rubber enclosure 20 has a lower portion integrally formed with a protruding wiper 201. The wiper 201 of the rubber enclosure 20 has multiple arc-shaped chamfered corners 202.

Accordingly, the elastic plate 21 is enclosed by the rubber enclosure 20 which is formed integrally so that the windshield wiper blade 2 is made easily and quickly, thereby decreasing the costs of fabrication. In addition, the windshield wiper blade 2 has a simplified construction, thereby decreasing the price of material, and thereby saving the manufacturing time. Further, the wiper 201 of the rubber enclosure 20 has multiple arc-shaped chamfered corners 202 to prevent the wiper 201 of the rubber enclosure 20 from being worn out during the wiping movement process. Further, the elastic plate 21 is fully enclosed by the rubber enclosure 20 closely and snugly so that the elastic plate 21 is not exposed to the ambient environment to prevent the elastic plate 21 from being rusted or eroded due to the rain or wet air, thereby maintaining the elasticity of the elastic plate 21, and thereby enhancing the lifetime of the elastic plate 21.

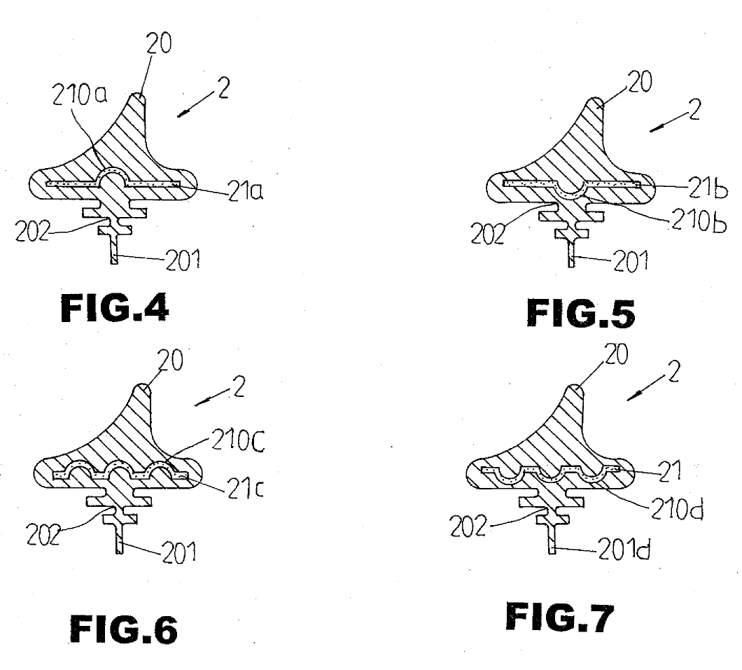

As shown in FIG. 4, the elastic plate 21a has a middle portion formed with an upward extending arc-shaped reinforcing portion 210a to enhance the strength of the elastic plate 21a.

As shown in FIG. 5, the elastic plate 21b has a middle portion formed with a downward extending arc-shaped reinforcing portion 210b to enhance the strength of the elastic plate 21b.

As shown in FIG. 6, the elastic plate 21c is provided with a plurality of upward extending arc-shaped reinforcing portions 210c to enhance the strength of the elastic plate 21c.

As shown in FIG. 7, the elastic plate 21d is provided with a plurality of upward extending arc-shaped reinforcing portions 210d to enhance the strength of the elastic plate 21d.

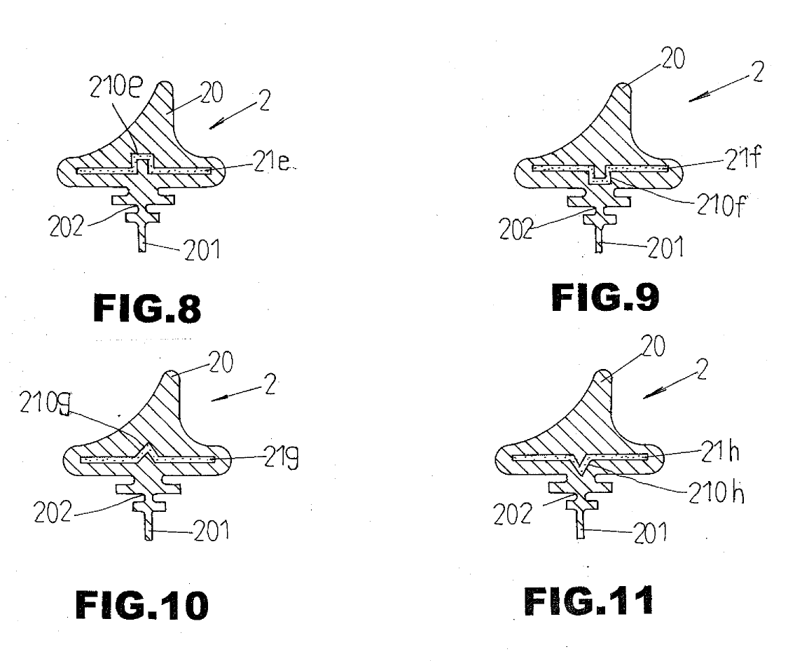

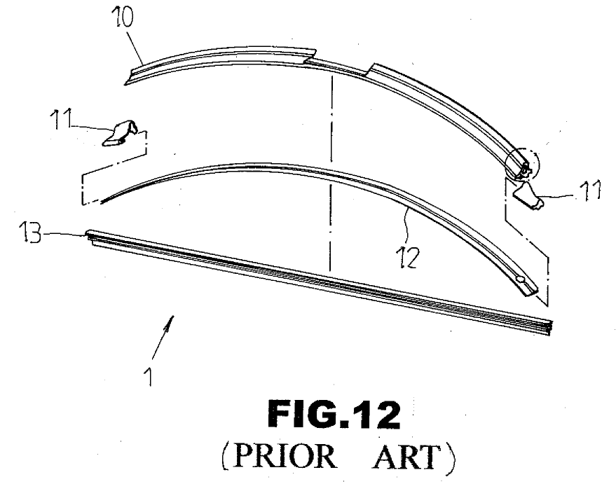

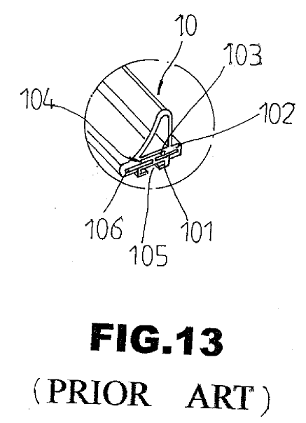

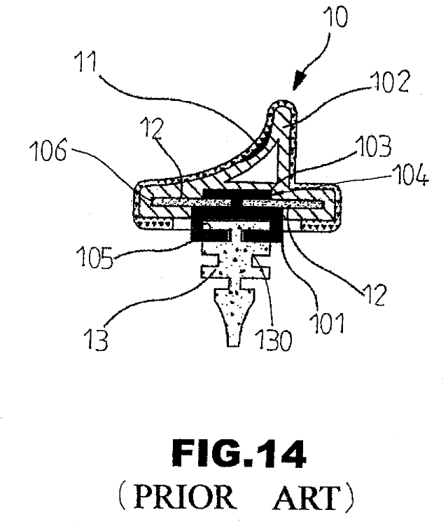

As shown in FIG. 8, the elastic plate 21e has a middle portion formed with an upward extending square reinforcing portion 210e to enhance the strength of the elastic plate 21e.

As shown in FIG. 9, the elastic plate 21f has a middle portion formed with a downward extending square reinforcing portion 210f to enhance the strength of the elastic plate 21f.

As shown in FIG. 10, the elastic plate 21g has a middle portion formed with an upward extending triangular reinforcing portion 210g to enhance the strength of the elastic plate 21g.

As shown in FIG. 11, the elastic plate 21h has a middle portion formed with a downward extending triangular reinforcing portion 210h to enhance the strength of the elastic plate 21h.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A windshield wiper blade, comprising:
an elastic plate;
a rubber enclosure enclosed around the elastic plate.

2. The windshield wiper blade in accordance with claim 1, wherein the rubber enclosure is formed integrally.

3. The windshield wiper blade in accordance with claim 1, wherein the rubber enclosure is enclosed around a whole periphery of the elastic plate.

4. The windshield wiper blade in accordance with claim 1, wherein the rubber enclosure has a lower portion integrally formed with a protruding wiper.

5. The windshield wiper blade in accordance with claim 4, wherein the wiper of the rubber enclosure has multiple arc-shaped chamfered corners.

6. The windshield wiper blade in accordance with claim 1, wherein the elastic plate is enclosed by the rubber enclosure which is formed integrally so that the windshield wiper blade is made easily and quickly, thereby decreasing cost of fabrication.

7. The windshield wiper blade in accordance with claim 1, wherein the elastic plate is fully enclosed by the rubber enclosure closely and snugly.

8. The windshield wiper blade in accordance with claim 1, further comprising two end caps mounted on two opposite ends of the rubber enclosure respectively to cover the elastic plate.

9. The windshield wiper blade in accordance with claim 8, wherein the elastic plate has two opposite ends exposed from the two opposite ends of the rubber enclosure respectively and covered by the two end caps respectively.

10. The windshield wiper blade in accordance with claim 1, wherein the elastic plate has a substantially flat-shaped cross-sectional profile.

11. The windshield wiper blade in accordance with claim 1, wherein the elastic plate has a middle portion formed with an upward extending arc-shaped reinforcing portion.

12. The windshield wiper blade in accordance with claim 1, wherein the elastic plate has a middle portion formed with a downward extending arc-shaped reinforcing portion.

13. The windshield wiper blade in accordance with claim 1, wherein the elastic plate is provided with a plurality of upward extending arc-shaped reinforcing portions.

14. The windshield wiper blade in accordance with claim 1, wherein the elastic plate is provided with a plurality of upward extending arc-shaped reinforcing portions.

15. The windshield wiper blade in accordance with claim 1, wherein the elastic plate has a middle portion formed with an upward extending square reinforcing portion.

16. The windshield wiper blade in accordance with claim 1, wherein the elastic plate has a middle portion formed with a downward extending square reinforcing portion.

17. The windshield wiper blade in accordance with claim 1, wherein the elastic plate has a middle portion formed with an upward extending triangular reinforcing portion.

18. The windshield wiper blade in accordance with claim 1, wherein the elastic plate has a middle portion formed with a downward extending triangular reinforcing portion.
